(19) United States
(12) Patent Application Publication
(10) Pub. No.: US 2005/0232705 A1
(43) Pub. Date: Oct. 20, 2005

(54) Process and system for the installation of pipelines in shallow or very shallow water

(75) Inventors: Cristian Scainl, Bergamo (IT); Umberto Giovannin I, Milan (IT)

Correspondence Address: OBLON, SPIVAK, MCCLELLAND, MAIER & NEUSTADT, P.C., 1940 DUKE STREET, ALEXANDRIA, VA, 22314, US

(73) Assignee: SAIPEM S.p.A, San Donato Milanese-Milan (IT)

(21) Appl. No.: 10/525,460

(22) PCT Filed: Dec. 5, 2003
(86) PCT No.: PCT/EP03/14779

§ 371 Date: Feb. 24, 2005

(30) Foreign Application Priority Data
Dec. 20, 2002 (IT) MI2002A002714

(51) Int. Cl. F16L 1/00; B63B 35/04

(52) U.S. Cl. 405/159; 405/154.1; 405/161

(57) ABSTRACT

A process for pipeline installation in shallow or very shallow water. The process includes trench excavation used for positioning/guiding pipes (“pre-trenching”); optional dragging of the pipes during the pre-trenching; cleaning and maintenance of the trench in the dragging; underground insertion of the pipes positioned at a required level (“post-trenching”); possible covering of the inserted pipes (“back-filling”). The operations are effected by coordinated use of vehicles of: a tracked transport vehicle or a vehicle with tires; an autonomous power and control module to power the vehicle, equipped with an operator cabin, being either positioned on the vehicle chassis or detached and placed on a floating craft, connected to the vehicle by an umbilical duct. The vehicles are assigned to transport one or more equipment items each having one of the following functions: “pre-trenching”, “trench maintenance”, “post-trenching”, possibly dragging and/or “back-filling”, so that all the equipment having the above functions is present within the whole group of vehicles used.

The present invention relates to a process and relative system for the installation of pipelines in shallow water (less than 10 m, for example) or very shallow water (typically less than 3 m), particularly in zones with difficult access (shallow coastal water, lagoons, difficult landing sites, periodically iced areas, etc.). The installation of underground pipes in very shallow water zones, for considerable lengths (more than 3 km, for example), does not allow the use of conventional floating laying and digging systems, whereas the methods normally used for landing sites (land dragging) can only be used for limited lengths.

For the construction of pipelines and sealines in areas with difficult access, typically due to the fact that they are on the border between the sea and dry land, huge dredging machines are normally used to create a channel for the pipe-laying vessel (which would have an excessive draught with respect to the seabed), or the dry land is extended with embankments to allow the use of land equipment (excavators) thus enabling the pipe to be dragged inside the prepared area (through “pre-trenching”).

“Back-filling” is required to guarantee protection of the pipeline, effected with the same dredgers, with specific excavators or with filling material from embankments.

The water depth does not allow the use of dry land installation methods (excavator, side-boom), and neither is marine equipment suitable, due to the shallowness of the water.

Extensive dredging and excavation operations have a high environmental impact and high costs (mobilization and operative). The use of embankments or spiles is only possible for limited distances, less than one kilometer.

Furthermore, adverse meteorological or marine conditions can damage the “pre-trenching” and support operations, even after the insertion of the pipe in the trench.

The main problem is the preparation of a “channel” in which the pipe can move easily (usually partially floating) and the subsequent securing of the pipe by the “back-filling” of the channel.

The problem has been solved by means of a process and the relative system, characterized by the coordinated use of various specialized machines, having a modular structure and of an amphibious nature.

The process claimed defines the operations and necessary instrumentation for preparing a trench, carrying the pipe in loco, placing the pipe on the seabed, positioning it at the required depth and covering it, also for extremely long distances (for example, over 3 km) and also in very shallow water (typically less than 3 m).

The process claimed allows the reduced movement of material, with a minimum environmental impact and minimum exposure of the excavated area (of the channel and, subsequently, of the pipe)to any possible adverse meteorological conditions.

The process, object of the present invention, for the installation of pipes in shallow or very shallow water essentially comprising the following steps:
excavation of a trench used for the positioning/guiding of pipes (“pre-trenching”)
optional dragging of the pipes during the trenching operations;
cleaning and maintenance of the trench in the dragging phases;
underground insertion of said pipes positioned at the required level (“post-trenching”);
possible covering of the inserted pipes (“back-filling”), is characterized in that said steps are effected by means of the coordinated use of vehicles essentially consisting of:
a tracked transport vehicle or a vehicle with tyres;
an autonomous power control module which powers said vehicle, equipped with a cabin for the operator, said module either positioned on the chassis of said vehicle or detached and placed on a floating craft, connected to the vehicle by means of an umbilical duct;
   said vehicles being assigned to transport one or more items of equipment each having one of the following functions: “pre-trenching”, trench maintenance, “post-trenching, so that all the equipment having the above-mentioned functions is present within the whole group of vehicles used.

When the pipe dragging and/or “back-filling” steps are present, the group of vehicles used will also include dragging and/or “back-filling” equipment.

A further object of the present invention relates to the system for installing pipes in shallow or very shallow water, characterized in that it comprises a single vehicle or more vehicles essentially consisting of:
a tracked transport vehicle or a vehicle with tyres (C);
an autonomous power and control module (P) which powers said vehicle, equipped with a cabin for the operator, said module being either positioned on the chassis of said vehicle or detached and placed on a floating craft, connected to the vehicle by means of an umbilical duct;
   said vehicle(s) being assigned to transport one or more items of equipment each having one of the following functions:
   “pre-trenching” (S), trench maintenance (M), “post-trenching” (U),
   said equipment, in the case of a single vehicle, being installed and alternatively substituted according to the operation to be performed, whereas, in the case of more vehicles, said equipment being installed to allow some of said operations to be possibly carried out simultaneously in several points of the installation of the pipeline.

The dragging (T) and/or “back-filling” (F) equipment can be present in the vehicle(s), said equipment being installed alone or together with one or more of the above-mentioned items of equipment.

When all of the above equipment is to be used, it preferable for it to be installed by distributing it on at least three vehicles.

It is preferable for at least one of the vehicles to have “pre-trenching” and dragging equipment, for at least one of the vehicles to have trench maintenance and dragging equipment, for at least one of the vehicles to have “back-filling” and dragging equipment, and for at least one of the vehicles to have “post-trenching” equipment.

Said vehicles can operate both on dry land and in water up to 10 meters deep, which means from the waterline to typically offshore water, thanks to the special transport vehicle, which always operates moving on the seabed, and to the central autonomous module of power and control, carried by the vehicle, said module, as it can only operate above water, being placed on the vehicle chassis, at a suitable height (up to a few meters, according to the maximum water seal allowed) or, for higher water seals, detached from the vehicle chassis and placed on a floating craft from which it supplies power to the vehicle, even when this is completely immersed in the water, through an umbilical duct. In this way, the use of the system is extended to deep water even several tens of meters deep.

The covering of the pipeline is mainly effected through digging operations after the pipe has been laid, whereas the “pre-trenching” allows the pipe to float in the direction chosen for its laying.

The process claimed introduces the concept of functional specialization of the system components, thus allowing a modular solution, which can be easily adapted to several different situations, and also a time sequence of the operations (even if not all of them are necessary).

The system described is modular and can therefore be reproduced whenever desired, by dividing the laying zone into several areas and operating simultaneously. This allows a reduction in the time necessary for completing the work, which is very important for particularly short operating periods.

The main role of the single tracked vehicle is to transport one or more items of equipment specifically designed for the pipeline installation (dragging winches, excavating tools, earth movement devices, etc.).

The advantage of the method is to minimize the amount of ground removed when the pipeline is inserted underground (which means a reduction in time, costs and environmental impact) and consequently the functional distribution between the “pre-trenching” phase (digging of the channel without the pipes, maintenance before the laying and/or during the dragging of the pipeline) and the “post-trenching” phase (underground insertion of the pipe), is particularly important.

“Pre-trenching” does not necessarily position the tube at the desired level (which is effected in the “post-trenching” phase) but mainly guarantees the floating and guiding of the pipe during its dragging, when the water depth is not sufficient. In zones with a very low seabed, in fact, the pipe can also reach its installation position by pulling while floating, i.e. with the pipe (partially) suspended, thanks to the buoyant force, so as to reduce friction against the seabed. The “pre-trenching” can be effected with a single run, moving a small amount of ground. In this case it is necessary to guarantee the integrity of the trench until dragging has been completed. The same floating-pulling operation can also be effected directly by one or more tracked vehicle(s) equipped with winches.

The “pre-trenching” can therefore be carried out by the tracked vehicle using a single run excavation device (for example a braking chain with suction pumps) installed at the back, and powered by the power module of the vehicle itself. In this way, the tracks are constantly laid on fresh ground, without entering into the trench.

Alternatively, the tracked vehicle can carry suction pumps destined for the cleaning and maintenance of the trench before and during the pipe laying.

The post trenching operation has a low environmental impact and is carried out using a special light vehicle which moves clamped to the pipe by means of driving wheels and carries digging equipment only (for example, tow milling cutters with suction pumps). In very low seabeds, this vehicle is powered by a short umbilical duct connected to the power module, which is positioned on a tracked vehicle which accompanies the above vehicle at its side. The vehicle can be alternatively equipped with hoisting equipment suitable for installing and transporting the vehicle itself.

In higher seabeds, on the contrary, the power module alone is installed on a floating craft, which assists the “post-trenching” by powering the vehicle through a suitable umbilical duct.

The vehicle can be equipped with stabilizing arms when operating in very low seabeds, whereas in deeper water it can be stabilized by means of suitable floating devices.

The excavating devices guarantee multiple runs, adequate for positioning the pipe at ditching levels of more than 4 meters.

In particular areas (for example, those periodically covered with ice), in addition to the ditching level of the pipe, it is also very important for the trench covering to be aligned to the ground (it is often required to use the same earth removed for the digging of the trench). For this purpose, a tool (for example a cochlea) can be installed on two tracked vehicles, for collecting the earth at the sides of the trench and throwing it into the trench itself. This kind of vehicle can also operate in very low seabeds or in deeper water (by removing the power and control module from the vehicle itself and positioning it on a floating craft).

The tracked vehicles can also be used for further functions, either for powering other equipment (for example, excavators, pneumatic drills, specific equipment), or they can act as assistant vehicles (for refueling, logistic support, transporting of materials and equipment, maintenance, towing and mooring of floating devices, etc.).

It is possible to use four vehicles (special tracked machines) for the embodiment of the proposed method, three of which to be prepared according to the function, equipped with the tools for the specific purposes, the fourth destined for “post-trenching”.

These machines can be used with a local configuration, consequently with the power and control module positioned on the same machine, for low seabed operations, or with a remote configuration, with the power module detached from the vehicle and connected to the same, through an umbilical duct. For example, possible configurations are as follows:
machine with “pre-trenching” and dragging function: a base vehicle equipped with excavating tools and a dragging winch, with a configuration for operating both in a low seabed (module positioned on the tracked vehicle) and in deep water (by inserting an umbilical hydraulic duct between the tracked base and the power/control module which can be installed on a lighter):
machine for trench maintenance and dragging: a base vehicle on which an arm is installed for cleaning the trench, together with a winch, also configured for operations both in low and deep water;
machine with “back-filling” and dragging functions: a base vehicle on which a cochlea is installed for transferring the filling material onto the pipe, and a winch also configured for operations both in low and deep water;
machine with a “post-trenching” function: a power/control vehicle which houses the power module and a crane (used for the installation of the “post-trenching” equipment and for specific lifting interventions, when necessary) and which powers, through a hydraulic umbilical duct, an excavating unit equipped with milling cutters, a roller transport system, which uses the pipe as a guide and a sucking system.

The power/control vehicle can move on the ground parallel to the digging module or it can be positioned on a lighter for excavations in deep water.

Auxiliary equipment can also be installed on the base vehicle, such as a digging arm for specific needs.

Vehicles for general interventions and logistic services may also be necessary, in addition to the above-mentioned machines.

A further object of the present invention relates to the “post-trenching” vehicle, characterized in that it essentially consists of:
a digging unit (U), equipped with milling cutters, a roller transport system, which uses the pipe as a guide and optionally a sucking system;
a possible transport tracked vehicle (C) or a vehicle with tyres, situated at the side of the digging unit and connected to the same through an umbilical duct (O);
an autonomous power and control module (P), equipped with an operator's cabin, which powers said vehicle, said module, when the vehicle is present, being positioned on the chassis of the vehicle itself, otherwise detached and connected to the digging unit through an umbilical duct (O) and placed on a floating craft (G).

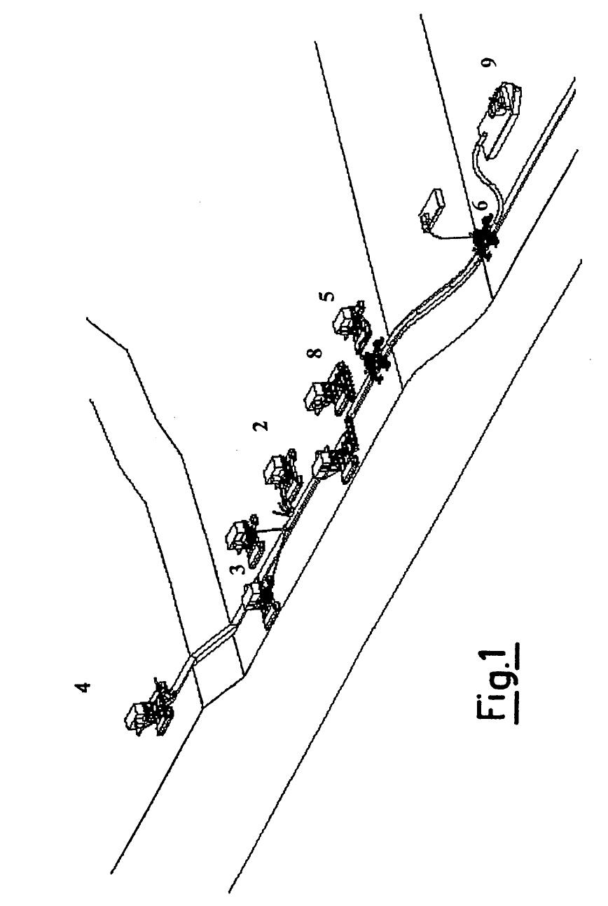

Some preferred embodiments are provided below, in accordance with the invention, with the help of FIGS. 1-8.

FIG. 1 represents an overall view of the vehicles during the installation operations of the pipeline, illustrating:
a vehicle with the function of trench maintenance (2);
two dragging vehicles (3);
the “pre-trenching” vehicle (4);
the “pre-trenching” vehicle with transport device (5);
the “post-trenching” vehicle (6) with the autonomous module situated on a floating craft;
two “back-filling” vehicles (8);
the floating craft for the laying of the pipeline (9).

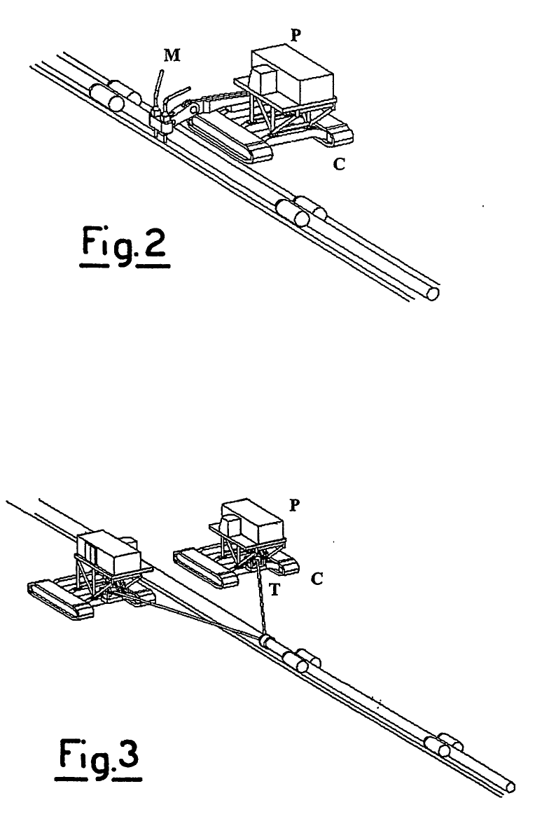

FIG. 2 represents the trench maintenance vehicle consisting of the tracked transport vehicle (C), the autonomous power and control module (P), situated on the vehicle chassis, and the maintenance equipment (M).

FIG. 3 represents two dragging vehicles consisting of the tracked transport vehicle (C), the autonomous power and control module (P), situated on the vehicle chassis, and the dragging equipment (T), during the pipe dragging operation.

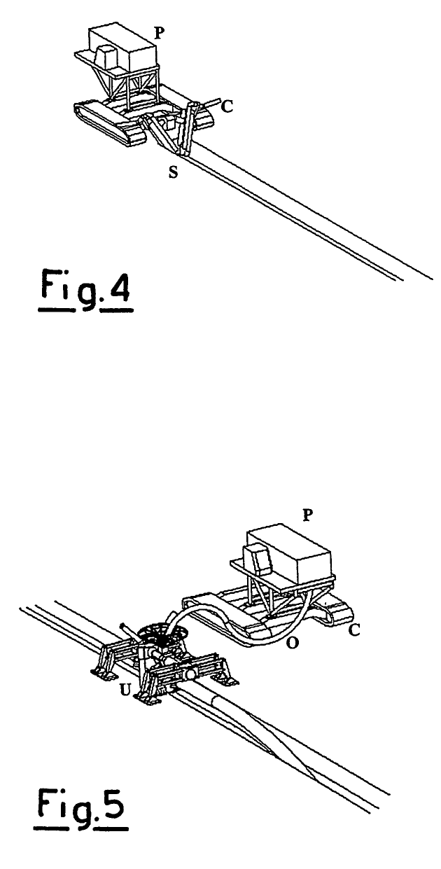

FIG. 4 represents the “pre-trenching” vehicle consisting of the tracked transport vehicle (C), the autonomous power and control module (P), situated on the vehicle chassis, and the “pre-trenching” equipment (S).

FIG. 5 represents the “post-trenching” vehicle consisting of the tracked transport vehicle (C), situated at the side of the digging unit (U), assembled on the pipe capable of moving and connected to the same through an umbilical duct (O), and the autonomous power and control modulus (P) situated on the vehicle chassis.

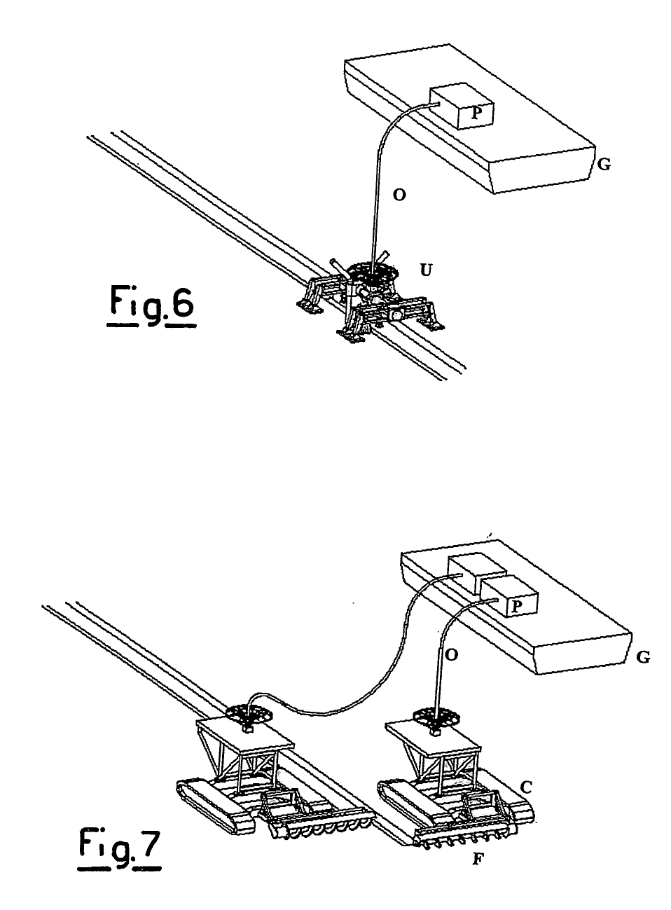

FIG. 6 represents the “post-trenching” vehicle consisting of the digging unit (U) assembled on the pipe, capable of moving, and the autonomous power and control modulus (P) situated on a floating craft (G) and connected to the digging unit through an umbilical duct (O).

FIG. 7 represents two “back-filling” vehicles consisting of the tracked transport vehicle (C), the “back-filling” equipment (F) and of the autonomous power and control modules (P) situated on a floating craft (G) and connected through umbilical ducts (O).

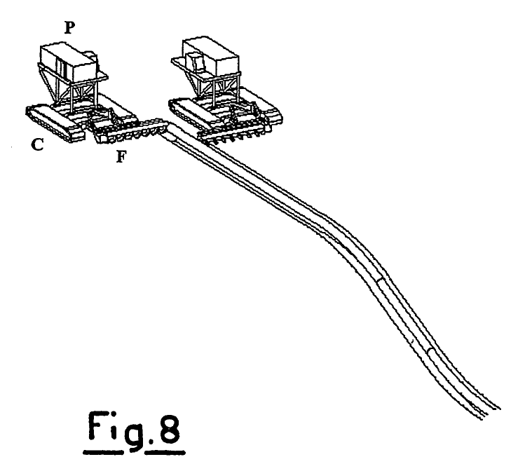

FIG. 8 represents two “back-filling” vehicles consisting of the tracked transport vehicle (C), of the autonomous power and control modules (P) placed on the vehicle chassis and the “back-filling” equipment (F), during the same operation.

1-19. (canceled)

20: A process for installation of pipes in shallow or very shallow water comprising:
excavation of a trench used for positioning/guiding of pipes as a pre-trenching;
cleaning and maintenance of the trench in dragging phases;
underground insertion of the pipes positioned at a required level as a post-trenching;
wherein operations are effected by use of vehicles comprising:
a tracked transport vehicle or a vehicle with tires;
an autonomous power control module that powers the vehicle, equipped with a cabin for an operator, the module being either supported by a chassis of the vehicle or detached and situated on a floating craft, connected to the vehicle;
the vehicles being assigned to transport one or more items of equipment each having one of the following functions: pre-trenching, maintenance of trenches, post-trenching, so that all equipment is present within a whole group of vehicles used.

21: The process according to claim 20, further comprising dragging of pipes during positioning of the pipes, situated after the pre-trenching, and before the trench cleaning and maintenance, the dragging equipment also being present, in this case, within the group of vehicles used.

22: The process according to claim 20, further comprising covering the inserted pipes as a back-filling, situated after the post-trenching, wherein in this case the back-filling equipment is also present within the group of vehicles used.

23: The process according to claim 21, wherein at least one of the vehicles is equipped with pre-trenching equipment and dragging equipment.

24: The process according to claim 21, wherein at least one of the vehicles includes trench maintenance equipment and dragging equipment.

25: The process according to claim 21, wherein at least one of the vehicles includes back-filling equipment and dragging equipment.

26: The process according to claim 23, wherein the vehicle is equipped with an excavating device and winch.

27: The process according to claim 25, wherein the vehicle is equipped with a cochlea for transferring the filling material onto the pipe, and a winch.

28: The process according to claim 20, wherein the vehicle with post-trenching equipment has a digging unit including milling cutters with suction pumps.

29: The process according to claim 28, wherein the digging unit is assembled on the pipe and is configured to move on the pipe itself.

30: The process according to claim 29, wherein the autonomous power and control module is detached, situated on a floating craft and connected, through an umbilical duct, to the digging unit assembled on the pipe, configured to move, the transport vehicle not being present.

31: A system for installation of pipes in shallow or very shallow water, comprising:
a single vehicle or more vehicles comprising:
a tracked transport vehicle or a vehicle with tires;
an autonomous power and control module that powers the vehicle, equipped with a cabin for an operator;
the module being either positioned on a chassis of the vehicle or detached and placed on a floating craft, connected to the vehicle through an umbilical duct;
the single vehicle or more vehicles being assigned to transporting one or more items of equipment each having one of the following functions: pre-trenching, trench maintenance, post-trenching,
said equipment, in a case of a single vehicle, being installed and alternatively substituted, according to an operation to be performed, whereas, in a case of more vehicles, the equipment being installed on the vehicles to allow some of the operations to be carried out simultaneously in plural points of the pipeline.

32: The system according to claim 31, wherein the dragging equipment and/or the back-filling equipment are present in the single vehicle or more vehicles, the equipment being installed alone or together with one or more of the other equipment for pre-trenching, trench maintenance, or post-trenching.

33: The system according to claim 32, wherein, in a case of more vehicles, the equipment for pre-trenching, trench maintenance, post-trenching, dragging, and back-filling is installed on at least three vehicles.

34: The system according to claim 32, wherein at least one of the vehicles is equipped with pre-trenching and dragging equipment, at least one of the vehicles is equipped with trench maintenance and dragging equipment, at least one of the vehicles is equipped with back-filling and dragging equipment, and at least one of the vehicles is equipped with post-trenching equipment.

35: The system according to claim 34, wherein at least one of the vehicles is equipped with excavating tools and a winch, at least one of the vehicles is equipped with a cochlea for transferring the filling material onto the pipe, and a winch, and at least one of the vehicles is equipped with a digging unit, comprising milling cutters with suction pumps.

36: The system according to claim 35, wherein the digging unit of the vehicle with the equipment for post-trenching is assembled on the pipe and is configured to move on the pipe itself.

37: The system according to claim 36, wherein the autonomous power and control module is detached, situated on a floating craft and directly connected to the digging unit assembled on the pipe and is configured to move, through an umbilical duct, the transport vehicle not being present.

38: A post-trenching vehicle for installation of pipelines in shallow or very shallow water, comprising:
a digging unit, equipped with milling cutters and a roller transport system, which uses the pipe as a guide;
a tracked transport vehicle or a vehicle with tires, situated at a side of the digging unit and connected to the digging unit through an umbilical duct;
an autonomous power and control module, equipped with an operator's cabin, which powers the vehicle, the module, when the vehicle is present, being positioned on a chassis of the vehicle itself, otherwise detached and placed on a floating craft, and connected to the digging unit through an umbilical duct.

39: A vehicle according to claim 38, wherein the digging unit is further equipped with a suction system.
